(19) United States
(12) Patent Application Publication
(10) Pub. No.: US 2002/0067021 A1
(43) Pub. Date: Jun. 6, 2002

(54) Scooter having solid folding configuration

(76) Inventors: Bernhard Heringer, Taichung (TW); Ming Chin Cheng, Taichung (TW)

Correspondence Address: Bernhard Heringer, P.O. Box 63-99, Taichung, 406, TW

(21) Appl. No.: 09/729,521

(22) Filed: Dec. 1, 2000

(51) Int. Cl. B62M 1/00

(52) U.S. Cl. 280/274; 280/87.041

(57) ABSTRACT

A scooter includes a handle secured to the front portion of a board and rotatably relative to the board between an upright working position and a lowered folding position. A latch ring is slidably engaged on the handle and selectively engaged with the seat for securing the handle to the board at the upright working position and the lowered folding position. The latch ring includes one or more projections for engaging into the seat and for solidly securing the handle to the seat. A fastener or a quick release locking device may solidly secure the latch ring to the handle.

### BACKGROUND OF THE INVENTION

1. Field of the Invention

The present invention relates to a scooter, and more particularly to a scooter having a solid folding configuration for preventing the handle from being folded inadvertently.

2. Description of the Prior Art

Various kinds of typical scooters have been developed and widely used today. Some of the scooters comprise a handle foldable relative to a foot pedal or a supporting board between an upright working position and a lowered folding position. U.S. Pat. No. 5,183,129 to Powell discloses one of the foldable handle configurations of the typical scooters and includes a locking pin for locking the handle at the upright working position and a lowered folding position. However, the handle may be folded relative to the foot pedal or the supporting board inadvertently when the locking pin is disengaged from the handle and the supporting board inadvertently. In addition, the locking pin is required to be disengaged from the handle and the board and thus will be lost easily or inadvertently.

The present invention has arisen to mitigate and/or obviate the afore-described disadvantages of the conventional scooters.

### SUMMARY OF THE INVENTION

The primary objective of the present invention is to provide a scooter having a solid folding configuration for preventing the handle from being folded inadvertently.

In accordance with one aspect of the invention, there is provided a scooter comprising a board including a front portion, a handle including a first end rotatably secured to the front portion of the board with a shaft, the handle being rotatable relative to the board about the shaft between an upright working position and a lowered folding position, and a latch ring slidably engaged on the handle and selectively engaged with the seat for securing the handle to the board at the upright working position and the lowered folding position. The latch ring is slidably engaged on the handle and will not be disengaged from the handle and thus will not be lost inadvertently.

The front portion of the board includes a seat provided thereon, the seat includes an opening formed therein for receiving the first end of the handle, the opening of the seat is opened upward and opened rearward toward the board, for allowing the handle to be rotated relative to the board between the upright working position and the lowered folding position,

The seat includes an upper portion having at least one depression formed therein, and includes a rear portion having at least one cavity formed therein, the latch ring includes at least one projection extended therefrom for engaging into the depression and the cavity of the seat and for solidly securing the handle to the seat. The projection of the latch ring may be solidly be engaged in the depression of the seat when the handle is erected or perpendicular to the board or extended upward from the board.

The seat includes a pair of flanges extended rearward from the rear portion thereof and having the cavity of the seat formed therein.

The latch ring includes a pair of ears, and means for securing the ears together to secure the latch ring on the handle. The securing means includes a fastener engaged through the ears for securing the ears together. The securing means may also be a quick release locking device.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a partial exploded view of a scooter in accordance with the present invention;

FIGS. 2 and 3 are partial perspective views illustrating the operation of the scooter;

FIGS. 4 and 5 are partial plane schematic views illustrating the operation of the scooter.

### DETAILED DESCRIPTION OF THE PREFERRED EMBODIMENT

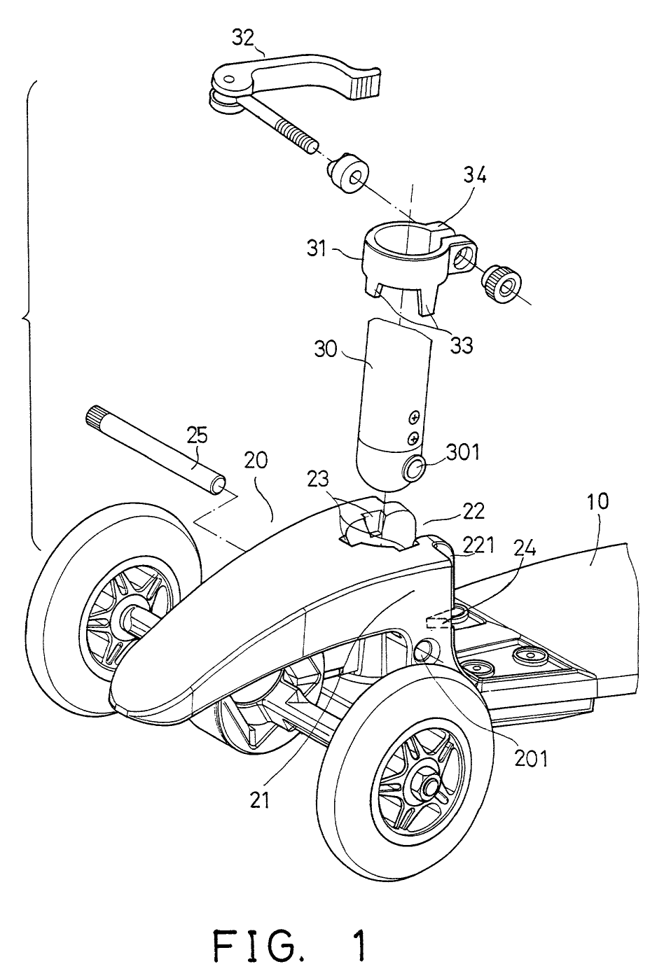

Referring to the drawings, and initially to FIGS. 1-3, a scooter in accordance with the present invention comprises a foot pedal or a supporting board 10 for supporting the users. The board 10 includes a front portion (20) having a frame 20 provided thereon, and includes a seat 21 extended upward from the front portion (20) thereof or provided in the frame 20. The seat 21 may be one portion of the board 10 or of the frame 20. The board 10 and the frame 20 and the seat 21 may also be an integral piece formed by such as molding processes or the like. The seat 21 includes an opening 22 formed therein and opened upward and opened rearward toward the board 10.

A handle 30 includes a lower portion received in the opening 22 of the seat 21 and having a hole 301 formed therein for receiving a shaft 25 which is engaged through the hole(s) 201 of the seat 21 for pivotally or rotatably securing the handle 30 to the seat 21 and thus to the board 10 and the frame 20. The opening 22 of the seat 21 is opened upward and opened rearward toward the board 10 such that the handle 30 may be rotated relative to the seat 21 and the frame 20 and the board 10 between an upright working position that is perpendicular to the board 10 and a lowered folding position that is parallel to and engaged with the board 10.

The seat 21 includes an upper portion having one or more depressions 23 formed therein and communicating with the opening 22 thereof, and includes a rear portion (221) having a pair of flanges 221 extended rearward therefrom and having one or more cavities 24 formed in the rear portion thereof or formed in the flanges 221.

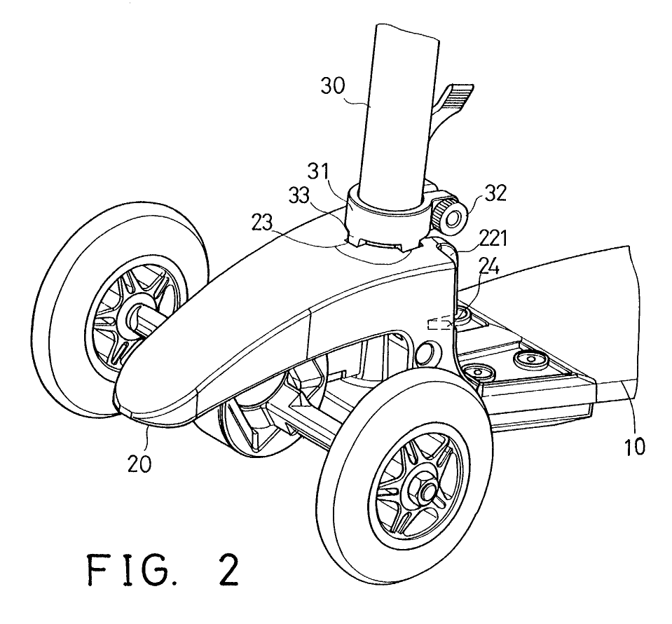

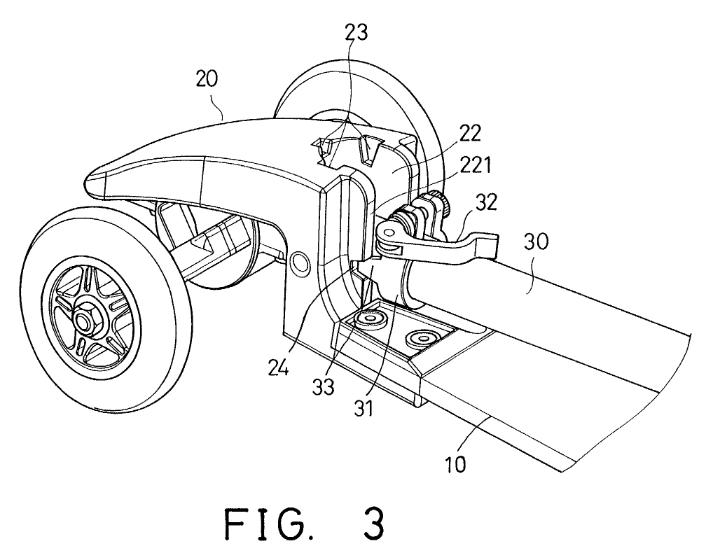

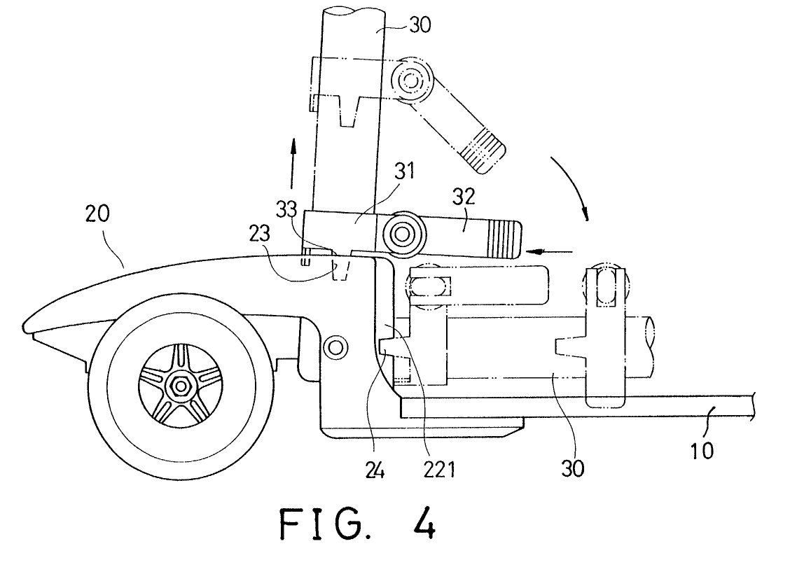

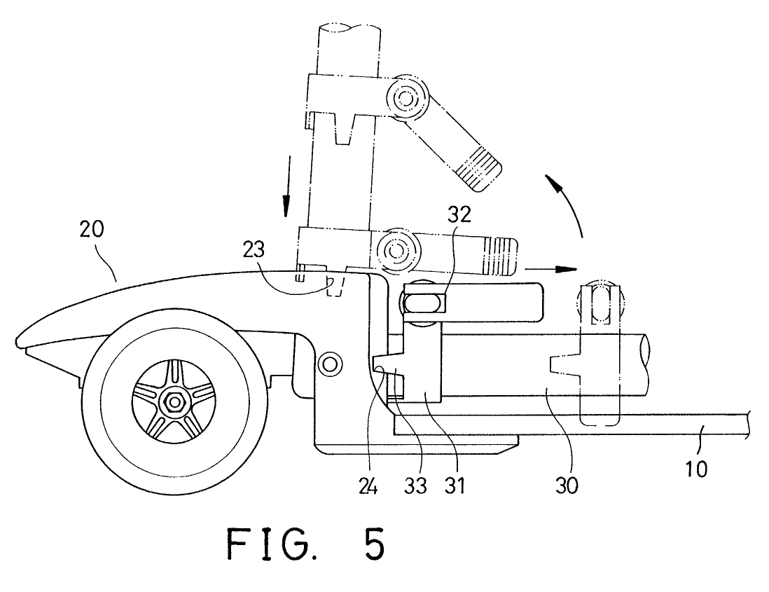

A latch ring 31 is slidably engaged on the handle 30 and includes one or more projections 33 extended therefrom for engaging with the depressions 23 of the seat 21 (FIGS. 2, 4) in order to secure the handle 30 at the upright working position that is perpendicular to the board 10, and for engaging with the cavities 24 of the seat 21 (FIGS. 3, 5) in order to secure the handle 30 at the lowered folding position that is parallel to and engaged with the board 10. The projections 33 of the latch ring 31 are preferably wedge shaped or the like for facilitating the engagement of the projections 33 into the depressions 23 or the cavities 24 of the seat 21. The latch ring 31 includes two ears 34. A fastener or a typical quick release locking device 32 is engaged with the ears 34 of the latch ring 31 for securing the latch ring 31 to the handle 30 and thus to the seat 21 and the frame 20 and the board, and for preventing the latch ring 31 from being disengaged from the seat 21. Particularly, even when the fastener or the quick release locking device 32 is loosed inadvertently, the latch ring 31 and the projections 33 of the latch ring 31 may still be moved downward toward the seat 21 and inward of the opening 22 of the seat 21 by gravity, such that the handle 30 will not be folded relative to the seat 21 inadvertently.

In operation, as shown in FIGS. 2-5, when the fastener or the quick release locking device 32 is loosed or released, the latch ring 31 may be moved along the handle 30 and may be moved away from the seat 21 for allowing the handle 30 to be rotated between the upright working position and the lowered folding position. When or after the handle 30 has been rotated relative to the seat 21 and the frame 20 and the board 10 to either of the upright working position and the lowered folding position, the latch ring 31 and the projections 33 of the latch ring 31 may be moved to engage with the opening 22 and the depressions 23 or the cavities 24 of the seat 21, and may be secured to the handle 30 in order to solidly secure the handle 30 and the seat 21 and thus the frame 20 and the board 10 together. The handle 30 will not be folded or rotated relative to the seat 21 and the frame 20 and the board 10 inadvertently.

It is to be noted that the latch ring 31 is slidably engaged on the handle 30 and thus will not be disengaged from the handle 30 and will not lost inadvertently. The seat 21 may includes a peripheral recess or shoulder formed in the upper portion and/or in the rear portion thereof for further solidly and stably receiving the latch ring 31.

Accordingly, the scooter in accordance with the present invention includes a solid folding configuration for preventing the handle from being folded inadvertently.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A scooter comprising:
a board including a front portion,
a handle including a first end rotatably secured to said front portion of said board with a shaft, said handle being rotatable relative to said board about said shaft between an upright working position and a lowered folding position, and
a latch ring slidably engaged on said handle and selectively engaged with said seat for securing said handle to said board at said upright working position and said lowered folding position.

2. The scooter according to claim 1, wherein said front portion of said board includes a seat provided thereon, said seat includes an opening formed therein for receiving said first end of said handle, said opening of said seat is opened upward and opened rearward toward said board, for allowing said handle to be rotated relative to said board between said upright working position and said lowered folding position,

3. The scooter according to claim 2, wherein said seat includes an upper portion having at least one depression formed therein, and includes a rear portion having at least one cavity formed therein, said latch ring includes at least one projection extended therefrom for engaging into said at least one depression and said at least one cavity of said seat and for solidly securing said handle to said seat.

4. The scooter according to claim 3, wherein said seat includes a pair of flanges extended rearward from said rear portion thereof and having said at least one cavity of said seat formed therein.

5. The scooter according to claim 1, wherein said latch ring includes a pair of ears, and means for securing said ears together to secure said latch ring on said handle.

6. The scooter according to claim 5, wherein said securing means includes a fastener engaged through said ears for securing said ears together.

7. The scooter according to claim 5, wherein said securing means is a quick release locking device.
